(19) United States
(12) Patent Application Publication
(10) Pub. No.: US 2016/0088634 A1
(43) Pub. Date: Mar. 24, 2016

(54) WIRELESS PACKET SCHEDULING FOR SATELLITE POSITIONING SYSTEM COEXISTENCE

(71) Applicant: QUALCOMM Incorporated, San Diego, CA (US)

(72) Inventors: Jibing WANG, San Diego, CA (US); Emilija Milorad SIMIC, La Jolla, CA (US)

(21) Appl. No.: 14/494,945

(22) Filed: Sep. 24, 2014

(51) Int. Cl. H04W 72/08; H04W 28/02; G01S 19/21

(52) U.S. Cl. CPC H04W 72/082; G01S 19/21; H04W 28/0236

(57) ABSTRACT

Techniques are disclosed for managing wireless transmission duty cycle on a mobile device to mitigate interference during reception of one or more satellite-based positioning signals and transmission of one or more wireless signals, involving (1) determining a first transmission duty cycle, the first transmission duty cycle reflecting a proportion of a time duration occupied by transmission of the one or more wireless signals and (2) delaying transmission of a first wireless packet or transmitting at least one portion of the first wireless packet via the one or more wireless signals, based on a comparison of the first transmission duty cycle and a duty cycle threshold.

### BACKGROUND

Aspects of the disclosure relate to wireless packet scheduling for satellite positioning system coexistence. Interference can occur when a mobile device attempts to simultaneously receive satellite positioning system (SPS) signals and transmit wireless signals. Such interference is referred to as a “desense” problem. That is, the mobile device's reception of the SPS signal is impaired, or desensed, by interference arising from the transmission of wireless signals from the same mobile device. The interference signal can be either an inter-modulation product of the wireless signal or the wireless signal itself. There is a need to address issues associated with the transmission of wireless signals and the potential interference that can result and affect the reception of SPS signals

### BRIEF SUMMARY

In one example, a method is disclosed for managing wireless transmission duty cycle on a mobile device to mitigate interference during reception of one or more satellite-based positioning signals and transmission of one or more wireless signals. The method includes (1) determining a first transmission duty cycle, the first transmission duty cycle reflecting a proportion of a time duration occupied by transmission of the one or more wireless signals and (2) delaying transmission of a first wireless packet or transmitting at least one portion of the first wireless packet via the one or more wireless signals, based on a comparison of the first transmission duty cycle and a duty cycle threshold. In one scenario of the example, transmission of the first wireless packet is delayed, in response to the first transmission duty cycle being greater than or equal to the duty cycle threshold. In another scenario of the example, the at least one portion of the first wireless packet is transmitted, in response to the first transmission duty cycle being less than the duty cycle threshold.

### BRIEF DESCRIPTION OF THE DRAWINGS

Aspects of the disclosure are illustrated by way of example. In the accompanying figures, like reference numbers indicate similar elements.

FIG. 1 illustrates a simplified diagram of an environment in which the reception of SPS signals may be desensed as a result of the transmission of wireless signals;

FIG. 2 depicts various components of a mobile device capable of wireless packet scheduling for satellite positioning system coexistence, according to one embodiment of the present invention;

FIG. 3 is a flow chart describing main features of a wireless TX packet scheduling method, according to an embodiment of the invention;

FIG. 4 is an example timing diagram illustrating when a WLAN TX packet may be scheduled, following the wireless TX packet scheduling method shown in FIG. 3;

FIG. 5 is an example timing diagram illustrating how the length of a WLAN TX packet may be limited, following the wireless TX packet scheduling method shown in FIG. 3;

FIG. 6 is a flow chart illustrating a process that may be performed for truncating a packet in order to avoid exceeding the TX duty cycle threshold, according to an embodiment of the invention.

FIG. 7 presents the same timing diagram shown in FIG. 5, along with a plot showing the WLAN TX duty cycle at various moments in time;

FIG. 8A is a flow chart illustrating a process that may be performed on a mobile device to mitigate interference during reception of one or more satellite-based positioning signals and transmission of one or more wireless signal, according to an embodiment of the invention;

FIG. 8B is a flow chart illustrating a process that may be performed on a mobile device to mitigate interference during reception of one or more satellite-based positioning signals and transmission of one or more wireless signal, according to another embodiment of the invention; and

FIG. 9 illustrates a computing device that may be incorporated as part of a computing device, which may implement, perform, and/or execute any and/or all of the features and/or methods described herein.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

A common problem encountered by a mobile device having wireless communication capabilities as well as SPS capabilities is the coexistence of wireless communication and SPS systems within the mobile device. In particular, interference or “desensing,” can occur when a mobile device attempts to simultaneously transmit wireless signals and receive SPS signals. The transmission of the wireless signals and/or an intermodulation product arising from such transmission can lead to interference that impacts the proper reception of the SPS signals. For example, the interference may cause a failure to acquire one or more of the SPS signals, corruption of the SPS signals, reduction in the number/frequency of successfully received SPS signals such that SPS-based positioning is degraded, etc. Embodiments of the present invention are directed to controlling the transmission of wireless signals and reception of the SPS signals by the mobile device in order to address such “desensing” issues.

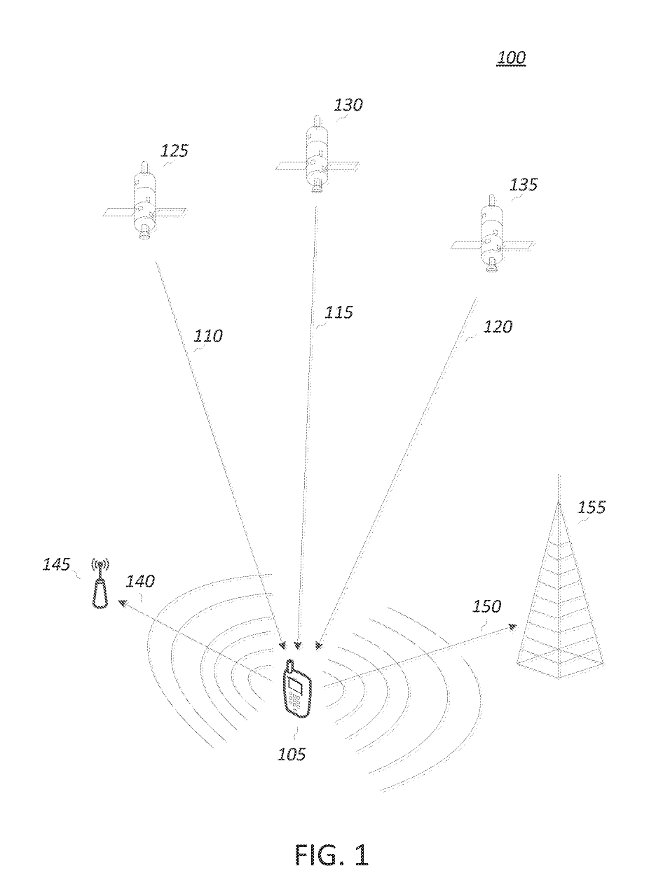

FIG. 1 illustrates a simplified diagram of an environment 100 in which the reception of SPS signals may be desensed as a result of the transmission of wireless signals by a mobile device. As shown, environment 100 includes a mobile device 105. Mobile device 105 may be a device designed to perform numerous functions, including the ability to determine its own location based on the reception of Satellite Positioning System (SPS) signals from satellites in orbit around Earth. Here, the term SPS is used in a general sense to refer to various types of satellite positioning systems, including different Global Navigation Satellite Systems (GNSS). For example, the SPS system may be a Global Positioning System (GPS), Global Navigation Satellite System (GLONASS), Galileo, Beidou, and/or other type of satellite positioning system. As described here, the SPS system may be one or more of these different types of systems used either alone or in conjunction with one another.

Mobile device 105 is able to perform satellite-based positioning by receiving SPS signals from one or more satellites. Such satellite-based positioning techniques are well-known and only briefly described below. As shown here, mobile device 105 receives SPS signals 110, 115, and 120 from satellites 125, 130, and 135, respectively. Typically, each of the SPS signals 110, 115, and 120 would include timing information relating to when the SPS signal was transmitted from the respective satellite. Each SPS signal may also include ephemeris information which can be used to determine the location of the satellite at the time the SPS signal is transmitted. Mobile device 105 is able to determine when it receives each of the SPS signals 110, 115, and 120. The transmission time and reception time of each SPS signal may be aligned on a common timing reference, such as a common clock, known to the mobile device 105. By taking the difference between the reception time and transmission time, mobile device 105 may compute the “flight time” associated with each SPS signal, for it to travel from the respective satellite to mobile device 105. The flight time can then be used to compute the distance between each satellite and mobile device, taking into account the speed of light. Once the distance between each satellite and the mobile device is found, trilateration may be used to compute the location of mobile device 105, based on the known location of each satellite and the distance between each satellite and mobile device 105.

In addition to satellite-based positioning, a significant category of functions performed by mobile device 105 relates to wireless communications. Wireless communications may serve as an important link in connecting mobile device 105 over private and/or public networks with other devices such as servers and other user equipment. This may include communication over various types of wireless networks, including wireless local area networks (WLAN) and wide area networks (WAN), among others. Examples of WLANs may be different types of WiFi networks, such as those implemented based on various 802.11 standards. The example in FIG. 1 focuses on wireless communications between mobile devices and base stations. However, other examples of wireless communications may include peer-to-peer communications between mobile devices such as WiFi Direct, Long-Term Evolution (LTE) Direct, etc. Additional examples of wireless communications may include near field communications (NFC), Bluetooth communications, etc. Embodiments of the present invention, including the control of transmission of wireless signals to avoid “desensing.” may be implemented with different types of wireless communication signals.

In the example shown in FIG. 1, mobile device 105 is able to perform wireless communications by sending signals to, and receiving signals from, one or more base stations. For instance, mobile device 105 may send a WLAN signal 140 to an access point 145, which may be a base station supporting WLAN communications. Mobile device 105 may send a WAN signal 150 to cell tower 155, which may be a base station supporting WAN communications. For instance, WLAN signal 140 and/or WAN signal 150 transmitted by mobile device 105 may include an HTTP request for a web page the user of mobile device 105 may wish to retrieve from the Internet. Not shown in FIG. 1 are the wireless signals that mobile device 105 may receive back in response to the request. Such signals may be sent to mobile device 105 from access point 145 and/or cell tower 155 and may include an HTTP response containing the HTML file constituting the requested web page. FIG. 1 highlights the wireless signals transmitted from mobile device 105 (as opposed to wireless signals received by mobile device 105), because various embodiments of the present invention addresses techniques to control the scheduling of wireless signal transmissions from the mobile device, to reduce interference caused by such transmitted signals.

For example, if mobile device 105 simultaneously attempts to receive SPS signals such as 110, 115, and 120 and transmit wireless signals such as 140 and 150, interference may occur to “desense” the proper reception of the SPS signals. This can occur if received SPS signals 110, 115, and 120 and transmitted wireless signals 140 and 150 utilize common or overlapping frequencies. This can also occur even when received SPS signals 110, 115, and 120 and transmitted wireless signals 140 and 150 do not utilize common or overlapping frequencies, but intermodulation products introduce interference.

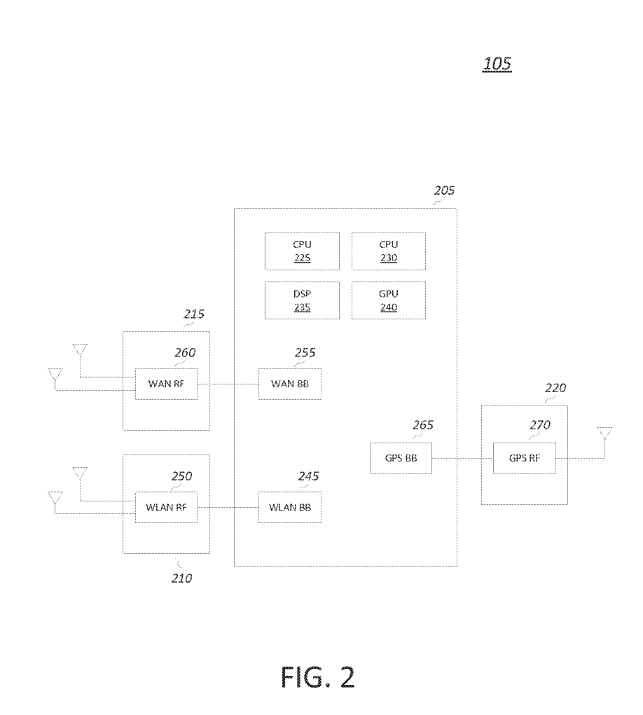

FIG. 2 depicts various components of mobile device 105 (from FIG. 1) capable of wireless packet scheduling for satellite positioning system coexistence, according to one embodiment of the present invention. In particular, select components of mobile device 105 relevant to wireless communications and satellite positioning are shown. While mobile device 105 may and typically does include other components, such other components are omitted from this figure to clarify discussion. It should be understood that mobile device 105 may include components not depicted in FIG. 2.

As shown in FIG. 2, mobile device 105 may include a processor system 205, a WLAN transceiver 210, a WAN transceiver 215, and a GPS receiver 220. Processor system 205 may be implemented in the form of a semiconductor chip and may have a variety of functionalities built in. Processor system 205 may include multiple processor cores such as a central processing unit (CPU) core 225, a CPU core 230, a digital signal processor (DSP) core 235, and a graphics processing unit (GPU) core 240.

Processor system 205 may also include a WLAN baseband (WLAN BB) unit 245. WLAN BB unit 245 is connected to and communicates baseband data (i.e., bits) with a WLAN radio frequency (WLAN RF) unit 250 residing in WLAN transceiver 210. In the transmit direction, WLAN RF unit 250 modulates and sends RF signals embodying WLAN communications to one or more antennas. In the receive direction, WLAN RF unit 250 receives and demodulates RF signals embodying WLAN communications from one or more antennas. For example, these RF signals may occupy frequencies at 2.4 GHz and/or 5 GHz in the frequency spectrum, which are known frequencies for WLAN signals.

Processor system 205 may also include a WAN baseband (WAN BB) unit 255. WAN BB unit 255 is connected to and communicates baseband data with a WAN radio frequency (WAN RF) unit 260 residing in WAN transceiver 215. In the transmit direction, WAN RF unit 260 modulates and sends RF signals embodying WAN communications to one or more antennas. In the receive direction, WAN RF unit 260 receives and demodulates RF signals embodying WAN communications from one or more antennas. For example, these RF signals may occupy frequencies at 800 MHz, 1.7 GHz and/or 1.9 GHz in the frequency spectrum, which are known frequencies for WAN signals.

Furthermore, processor system 205 may include a GPS baseband (GPS BB) unit 265. GPS BB unit 265 is connected to and communicates baseband data with a GPS radio frequency (GPS RF) unit 270 residing in GPS receiver 220. GPS RF unit 270 may receive GPS signals from one or more antennas. These GPS signals may occupy frequencies at 1.5 and/or 1.6 GHz in the frequency spectrum, which are known frequencies for GPS signals or other types of SPS signals. While a GPS system is depicted in the figure, different types of SPS systems may be used in mobile device 105 in accordance with various embodiments of the invention.

As mentioned previously, interference or “desensing” can occur when mobile device 105 attempts to simultaneously transmits wireless signals (e.g., one or more WLAN and/or WAN signals) and receive SPS signals (e.g., GPS signals). This can result if the wireless signals and the SPS signals utilize common or overlapping frequencies. Interference can also result if the wireless signals and the SPS signals do not utilize common or overlapping frequencies, but intermodulation products (IM) introduce interference. Example frequencies that may be utilized by various type of wireless signals depicted in FIG. 2 are listed below:
GPS: 1.5/1.6 GHz
WLAN: 2.4 GHz or 5 GHz
WAN: 800 MHz or 1.7/1.9 GHz

For illustrative purposes, listed below are two potential IM products that may result from different combinations of these WAN and WAN signals:
(A) 800 MHz WAN and 2.4 GHz WLAN
   First order IM product at 1.6 GHz (2.4 GHz-800 MHz)
(B) 1.7/1.9 GHz WAN and 5 GHz WLAN
   Second order IM product at 1.6 GHz (5 GHz-2*1.7 GHz)

As can be seen, even though WLAN signals at 2.4 GHz or 5 GHz and WAN signals at 800 MHz or 1.7/1.9 GHz may not necessarily utilize the same frequency as GPS signals at 1.5/1.6 GHz, it is possible for IM products resulting from the mixing of such WLAN and WAN signals to land in the same frequencies utilized by GPS signals. Such IM products may thus interfere with and “desense” the proper reception of the GPS signals. While the two examples of IM products described above result from the transmission of signals belonging to different types of system (WAN and WLAN), it should be understood that IM products may also result from the transmission of signals belonging to the same type of system (e.g., WAN only).

According to various embodiments of the invention, mobile device 105 may control the timing of its wireless signal transmissions and SPS receptions, to avoid such interference situations. In particular, mobile device 105 may avoid the “desense” problem by implementing both (1) SPS RX blanking and (2) a wireless TX packet scheduling method.

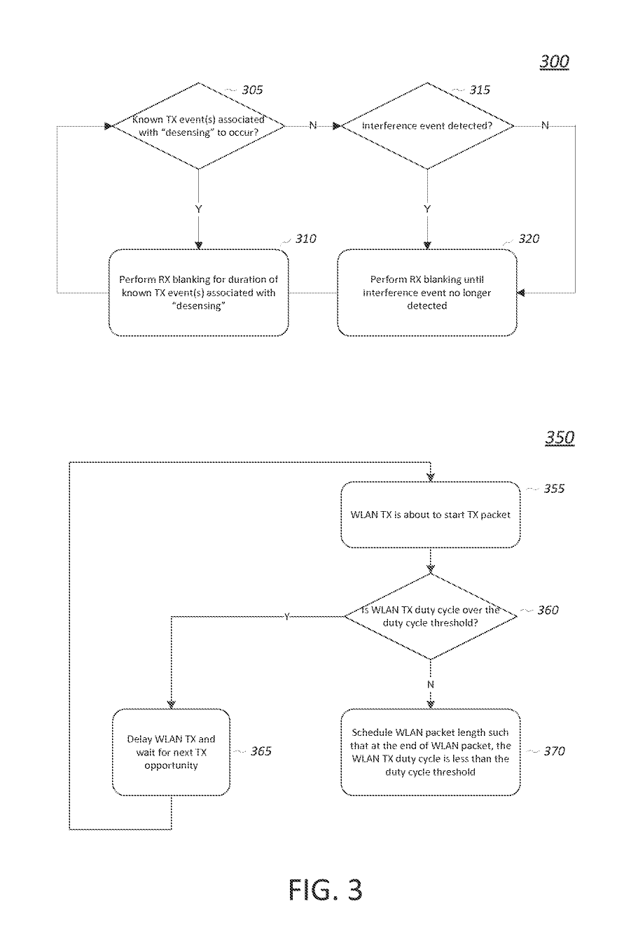

FIG. 3 is a flow chart showing two concurrent processes, an example process 300 for SPS RX blanking and an example process 350 for TX packet scheduling, that may be carried out according to various embodiments of the invention. SPS RX blanking refers to a technique whereby the mobile device disregards SPS signals (or results thereof) received whenever the mobile device is transmitting wireless signals that can result in “desensing.” The technique is used to avoid the situation of the received SPS signal being “desensed” by interference created by the transmission of one or more wireless signals from the mobile device. Accordingly, the GNSS signals received during such time periods are disregarded. Doing so ensures a high degree of confidence that the SPS signals that are used (received during periods when there is no interference or an insignificant amount of interference) are not desensed and can be relied upon.

Referring now to process 300 for SPS RX blanking shown in FIG. 3, at block 305, the process involves determining whether known TX event(s) associated with “desensing” are about to occur. Here, for example, mobile device 105 may recognize certain wireless signal transmissions (or combination of transmissions) associated with a potential desensing situation. This can be referred to as an a priori approach, in the sense that mobile device 105 is able to determine when to perform SPS RX blanking based on knowledge of which wireless signals are to be transmitted. Referring to an example discussed previously, for instance, when mobile device 105 is to simultaneously transmit a 800 MHz WAN signal and a 2.4 GHz WLAN signal, a first order IM product at 1.6 GHz (2.4 GHz-800 MHz) is expected to occur that would likely lead to “desensing” of SPS signal reception, in particular the reception of GPS signals at 1.5/1.6 GHz. Different wireless signal transmissions and/or combinations of wireless signal transmissions may be identified as TX events associated with desensing and stored, for example, in a look-up table. When such a wireless transmission/combination of wireless transmissions is recognized, SPS RX blanking may be performed.

Furthermore, the transmit power level of the wireless signal(s) may be considered in the determination made at block 305. In other words, transmission of one or more wireless signals may or may not be considered a known TX event associated with “desensing,” depending on the power level at which the wireless signal(s) are transmitted. In the case of two or more wireless signals forming an intermodulation product, it may be the case that an interference condition is only met when both (or more than two) of the wireless signals associated with a potential intermodulation product are transmitted at a power level above a certain power level threshold. For example, the interference condition may correspond to the simultaneous transmission of a WLAN signal above a particular power level threshold and a WAN signal at above a particular power level threshold.

If a known TX event associated with “desensing” is about to occur, the process continues to block 310, where SPS RX blanking is performed. Here, the duration of the problematic TX event is likely to be known, and blanking may be performed for such duration. Otherwise, if no known TX event associated with “desensing” is about to occur, the process continues to block 315.

At block 315, the process involves determining whether an interference event is detected. Here, the interference event refers to an event that is actually detected as result of interference occurring (as opposed to just the transmission of certain wireless signals or combination of wireless signals associated with desensing). This can be referred to as a reactive approach. Examples of such a detected interference event may include the failure to acquire one or more of the SPS signals, the signal strength of one or more SPS signals falling below a certain level, the detection of signal spurs or other interference within the receive frequency band of the one or more SPS signals, etc. If an interference event is detected, the process continues to block 320, where SPS RX blanking is performed. Here, SPS RX blanking may be performed until the interference condition is no longer detected. If an interference event is not detected or no longer detected, the process returns to block 305. While process 300 illustrates the use of both an a priori approach and a reactive approach in combination, either approach may be used alone for triggering SPS RX blanking, according to an embodiment of the invention.

To implement SPS RX blanking, a mobile device such as mobile device 105 may utilize processors such as CPU cores 225 and/or 230 in conjunction with GPS BB unit 265. For example, CPU cores 225 and/or 230 may simply ignore SPS data bits received from GPS BB unit 265 during a period of blanking. As another example, CPU cores 225 and/or 230 may instruct GPS BB unit 265 to stop sending SPS data bits during a period of blanking and restart the sending of SPS data bits once the period of blanking has concluded. Blanking can also be implemented at a lower level, such as at the demodulation or RF level. For example, CPU cores 225 and/or 230 may instruct GPS BB unit 265 to idle or turn off certain operations of GPS RF unit 270 during a period of blanking. In response, GPS RF unit 270 may stop demodulating SPS signals and/or turn off other components in the receive chain of GPS RF unit 270. Turning off certain components may have the benefit of saving power during blanking. Different implementations may be chosen depending on system requirements.

Referring to process 350 for TX packet scheduling in FIG. 3, at block 355. WLAN TX is about to transmit a packet. That is, the portion of mobile device 105 responsible for WLAN transmissions has been given a packet to be transmitted. At block 360, the process evaluates whether the WLAN TX duty cycle over the latest time duration (20 ms in this example) is less than the duty cycle threshold (50% in this example). This operation can be performed by CPU cores 225 and/or 230 or WLAN BB unit 245, or some other component responsible for keeping track of the WLAN TX timing and duty cycle. If the answer to block 360 is “yes.” the duty cycle is greater than or equal to the duty cycle threshold (e.g., 50%), the process continues to block 365. This means the current TX WLAN duty cycle is either at or above the duty cycle threshold, so no WLAN packet should be transmitted, at least not at the current time. Thus, at block 365, mobile device 105 delays WLAN TX and waits for the next WLAN TX opportunity. If the answer to block 360 is “no,” the duty cycle is less than the duty cycle threshold (e.g., 50%), the process continues to block 370. This means the current TX WLAN duty cycle has not reached the duty cycle threshold, and therefore there is room for transmitting at least a portion of the TX WLAN packet. At block 370, mobile device 105 schedules the WLAN packet for transmission using an appropriate packet length such that at the end of the WLAN packet, the WLAN TX duty cycle over the latest time duration (e.g., 20 ms) is less than the duty cycle threshold (e.g., 50%). In other words, the WLAN packet may need to be truncated to an appropriate packet length that would not cause the WLAN TX duty cycle to exceed the duty cycle threshold (e.g., 50%).

The example WLAN TX packet scheduling method described above ensures that in any given 20 ms period, the duty cycle of WLAN transmission is no more than 50%. This guarantees that at least half of the time in any given 20 ms period would be available for reception of SPS signals that are not subject to “desensing.” In practice, SPS systems do not require reception of SPS signals 100% of the time. Receiving SPS signals at least 50% of the time within any given 20 ms period may be acceptable, especially if it is guaranteed that the SPS signals that are received will not be “desensed.” The 50% duty cycle translates to at most a 3 dB decrease in the amount of SPS signal received.

The needs of WLAN packet transmission are also well-met in the above example. Typically, the transmission of WLAN packets from the mobile device is intermittent in nature. These are transmissions, such as web page requests, that are sent in the uplink direction from the mobile device to the base station (e.g., access point, cell tower, etc.). Thus, these WLAN packet transmissions may not be expected to be sustained transmissions. Furthermore, it may be that a requested WLAN TX packet is scheduled immediately. That is, when transmission of the WLAN packet is requested, the duty cycle over the past 20 ms may very well be less than 50%, so the packet request is likely to be scheduled and not delayed. Also, it is likely that the length of the WLAN packet requested is not long enough to cause the duty cycle to exceed 50% over the past 20 ms. In other words, the WLAN packet is unlikely to be truncated. Thus, a WLAN TX packet scheduling method such as the one described above can often times be expected to only minimally affect the transmission of WLAN packets, but at the same time, it provides duty cycle guarantees for purposes SPS blanking.

It should be noted that the duty cycle threshold of 50% is described here for illustrative purposes. The threshold can be set to a different percentage. It can also be expressed in terms other than a percentage, such as a ratio. Furthermore, the time duration over which the TX duty cycle is measured is described as 20 ms for illustrative purposes, as well. A different time duration may be used. The time duration may also be expressed in units other than milliseconds. For example, it may be expressed in terms of clock cycles.

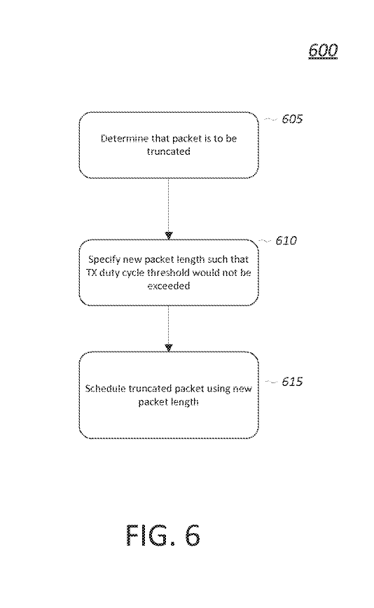

To implement the wireless TX packet scheduling method, a mobile device such as mobile device 105 may utilize CPU cores 225 and/or 230 as well as WLAN BB unit 245. For example, WLAN BB unit 245 may be primarily responsible for executing blocks 355 through 370. Thus. WLAN BB unit 245 may keep track of the timing of all WLAN packets, as well as the current WLAN TX duty cycle. When WLAN BB unit 245 receives a request to transmit a WLAN packet, it may either delay the WLAN packet until the next TX opportunity or schedule the WLAN packet for transmission, at an appropriate packet length so as not to exceed the 50% level (as discussed below with regard to FIG. 5). WLAN BB unit 245 may also generate, schedule, and transmit one or more additional WLAN packets carrying the remaining data left after truncation of the initial WLAN packet. Alternatively or additionally, CPU cores 225 and/or 230 may handle some or all of such tasks.

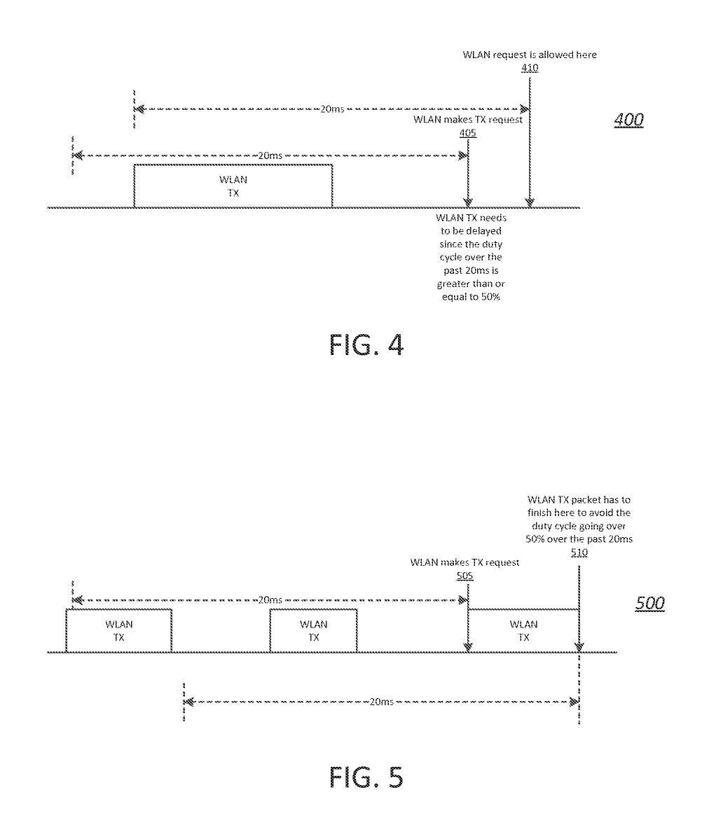

FIG. 4 is an example timing diagram 400 illustrating when a WLAN TX packet may be scheduled, following the wireless TX packet scheduling method shown in FIG. 3. Again, a duty cycle threshold of 50% and time duration of 20 ms, over which to measure the duty cycle, are used for illustrative purposes. As shown in FIG. 4, at time 405, a WLAN packet is requested to be transmitted. However, the WLAN TX duty cycle over the past 20 ms is greater than or equal to 50%. Thus, the WLAN packet is delayed and not scheduled at time 405. At a later time 410, which may be the next WLAN TX opportunity, the duty cycle is evaluated again. At time 410, the WLAN TX duty cycle over the past 20 ms is now less than 50%. Thus, the WLAN packet is allowed to be scheduled.

FIG. 5 is an example timing diagram 500 illustrating how the length of a WLAN TX packet may be limited, following the wireless TX packet scheduling method shown in FIG. 3. Here, the method specifies that when a WLAN packet is scheduled to be transmitted, the length of the WLAN packet must be limited to avoid the duty cycle going over 50% over the past 20 ms. As shown in the figure, at time 505, a WLAN packet is requested to be transmitted. The WLAN TX duty cycle at time 505 is less than 50%. Therefore the packet is allowed to be scheduled. However, in this example, the length of the packet is too long, and consequently the packet is truncated. Otherwise, at time 510, the WLAN TX duty cycle would exceed 50%. According to the present embodiment of the invention, the truncation is performed at time 505, when the packet is scheduled to be transmitted.

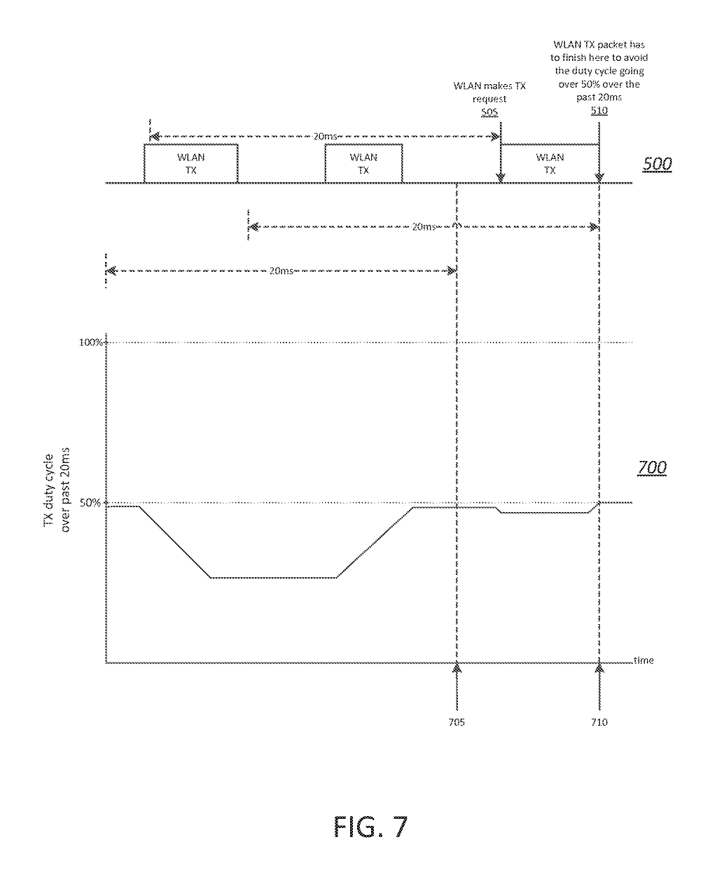

FIG. 6 is a flow chart 600 illustrating a process that may be performed for truncating a packet in order to avoid exceeding the TX duty cycle threshold, according to an embodiment of the invention. Following the example shown in FIG. 5, process 600 may be performed at time 505. At block 605, it is determined that the packet is to be truncated. At block 610, a new packet length is specified that would appropriately limit the length of the packet such that the packet would end without causing the TX duty cycle to exceed the TX duty cycle threshold. Again following the example in FIG. 5, the new packet length may be determined as the length corresponding to a duration of transmission starting at time 505 and ending at time 510. Such a packet length would ensure that the TX duty cycle would not exceed the TX duty cycle threshold of 50%, for instance. At block 615, the truncated packet with the new packet length may be scheduled. After truncation, the remainder portion of the original packet may be transmitted at a subsequent transmission opportunity. Blocks 605, 610, and 615 may be performed, for example, by WLAN BB unit 245 and/or WAN BB unit 255. Alternatively or additionally, blocks 605, 610, and 615 may be performed by one or more CPU cores 225 and/or 230.

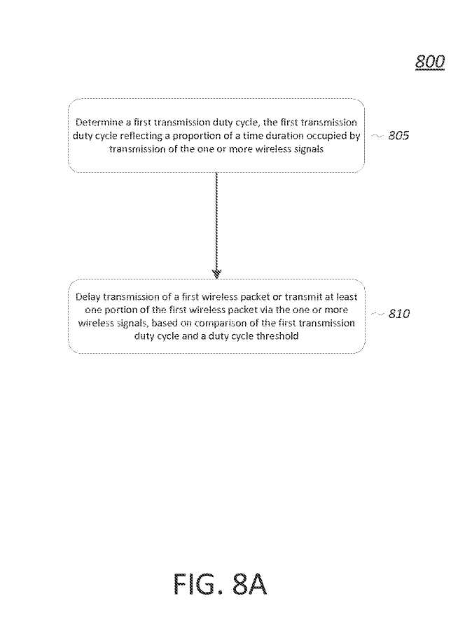

FIG. 7 presents the same timing diagram 500 shown in FIG. 5, along with a plot 700 showing the WLAN TX duty cycle at various moments in time. Plot 700 illustrates that the wireless packet scheduling method manages to keep the WLAN TX duty cycle below the 50% threshold, while the method is in place. In particular, at time 705, plot 700 shows the result of enforcing the requirement to truncate the length of the last WLAN packet to a length that would end the packet at time 510, so as to keep the WLAN TX duty cycle from exceeding the 50% threshold at time 510.

The instantaneous value of any point on plot 700 depends on WLAN TX activity over the past 20 ms. Thus, at time 705, the instantaneous value of plot 700 depends on the WLAN TX activity over the 20 ms time duration just prior to time 705. Similarly, at time 710, the instantaneous value of plot 700 depends on the WLAN TX activity over the 20 ms time duration just prior to time 710. Note that the instantaneous value of plot 700 prior to time 710 depends at least partially on WLAN TX activity not visible in FIG. 7.

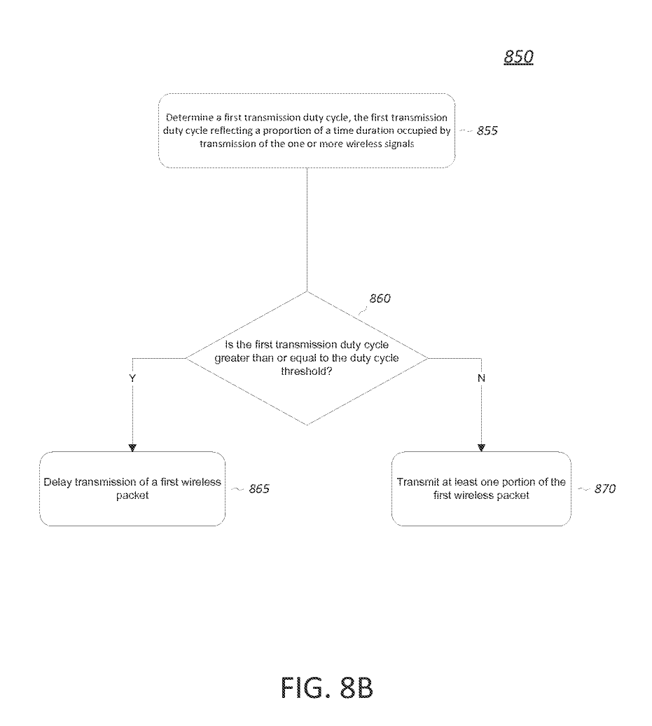

FIG. 8A is a flow chart 800 illustrating a process that may be performed on a mobile device (e.g., mobile device 105) to mitigate interference during reception of one or more satellite-based positioning signals (e.g., SPS signals 110, 115, and 120) and transmission of one or more wireless signal (e.g., WLAN signal 140 and WAN signal 150), according to an embodiment of the invention. At block 805, a first transmission duty cycle is determined. The first transmission duty cycle may reflect a proportion of a time duration occupied by transmission of the one or more wireless signals. At block 810, transmission of a first wireless packet is delayed, or at least one portion of the first wireless packet is transmitted via the one or more wireless signals, based on the comparison of the first transmission duty cycle and the duty cycle threshold (e.g., 50%). Blocks 805 and 810 may be performed, for example, by WLAN BB unit 245, WAN BB unit 255, one or more CPU cores 225 and 230, or any combination thereof.

FIG. 8B is a flow chart 850 illustrating a process that may be performed on a mobile device (e.g., mobile device 105) to mitigate interference during reception of one or more satellite-based positioning signals (e.g., SPS signals 110, 115, and 120) and transmission of one or more wireless signal (e.g., WLAN signal 140 and WAN signal 150), according to another embodiment of the invention. At block 855, a first transmission duty cycle is determined. The first transmission duty cycle may reflect a proportion of a time duration occupied by transmission of the one or more wireless signals. At block 860, if the first transmission duty cycle is greater than or equal to the duty cycle threshold (e.g., 50%), the process moves to block 865. At block 865, transmission of a first wireless packet is delayed. On the other hand, at block 860, if the first transmission duty cycle is less than the duty cycle threshold, the process moves to block 870. At block 870, at least one portion of the first wireless packet is transmitted. Blocks 855, 860, 865, and 870 may be performed, for example, by WLAN BB unit 245, WAN BB unit 255, one or more CPU cores 225 and 230, or any combination thereof.

While not explicitly shown in the figures, other types of processing devices such as one or more digital signal processors (DSPs) and/or graphics processing units (GPUs) may be used either in addition to or as alternatives for devices such as CPU core 225 and CPU core 230, for performing operations such as those described in FIG. 8A and FIG. 8B.

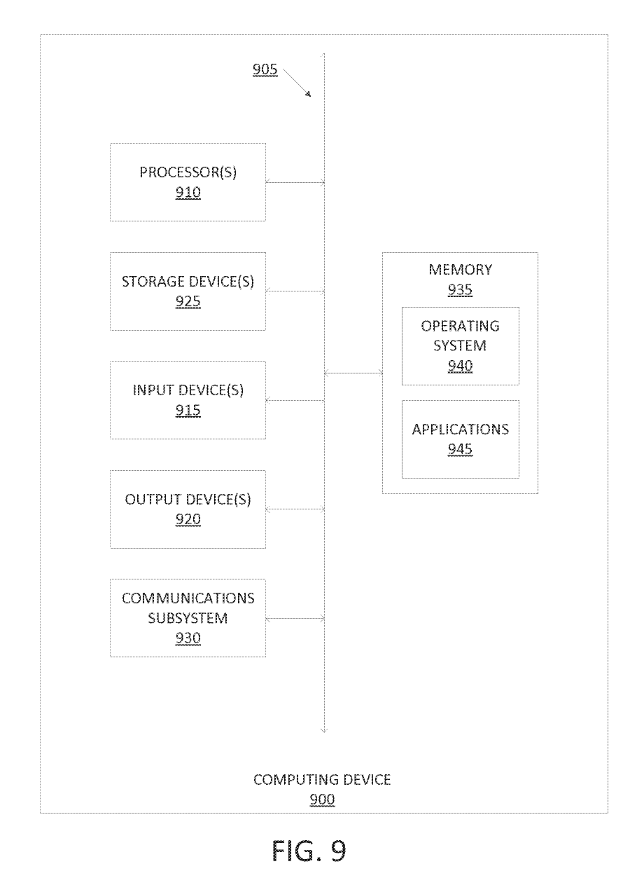

Having described multiple aspects of techniques for wireless packet scheduling for satellite positioning system coexistence, an example of a computing device in which various aspects of the disclosure may be implemented may now be described with respect to FIG. 9. According to one or more aspects, a computing device 900 as illustrated in FIG. 9 may be incorporated as part of a computing device, which may implement, perform, and/or execute any and/or all of the features and/or methods described herein. For example, the computing device 900 may represent some of the components of a mobile device. A mobile device may be any computing device with an input sensory unit, such as a camera and/or a display unit. Examples of a mobile device include but are not limited to tablets, smart phones, phablets, laptops, wearable devices, automobile equipment, etc. In one embodiment, the computing device 900 is configured to implement the mobile device 105 described above. FIG. 9 provides a schematic illustration of one embodiment of a computing device 900 that can perform the methods provided by various other embodiments, as described herein, and/or can function as the host computer system, a remote kiosk/terminal, a point-of-sale device, a mobile device, a set-top box, and/or a computer system. FIG. 9 is meant only to provide a generalized illustration of various components, any and/or all of which may be utilized as appropriate. FIG. 9, therefore, broadly illustrates how individual system elements may be implemented in a relatively separated or relatively more integrated manner.

The computing device 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a camera, a mouse, a keyboard and/or the like; and one or more output devices 920, which can include without limitation a display unit, a printer and/or the like.

The computing device 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computing device 900 might also include a communications subsystem 930, which can include without limitation a modem, a network card (wireless or wired), an infrared communication device, a wireless communication device and/or chipset (such as a Bluetooth device, a WiFi device, a WiMax device, cellular communication facilities, etc.), and/or the like. The communications subsystem 930 may permit data to be exchanged with a network (such as the network described below, to name one example), other computing systems, and/or any other devices described herein. In many embodiments, the computing device 900 may further comprise a non-transitory working memory 935, which can include a RAM or ROM device, as described above.

The computing device 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 8A and 8B, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the non-transitory storage device(s) 925 described above. In some cases, the storage medium might be incorporated within a computing device, such as computing device 900. In other embodiments, the storage medium might be separate from a computing device (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computing device 900 and/or might take the form of source and/or installable code, which, upon compilation and/or installation on the computing device 900 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computing device (such as the computing device 900) to perform methods in accordance with the disclosure. For example, some or all of the procedures of the described methods may be performed by the computing device 900 in response to processor(s) 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the non-transitory storage device(s) 925. Merely by way of example, execution of the sequences of instructions contained in the working memory 935 might cause processor(s) 910 to perform one or more procedures described herein, for example the procedures described with respect to FIGS. 8A and 8B.

The terms “machine-readable medium” and “computer-readable medium,” as used herein, refer to any medium that participates in providing data that causes a machine to operate in a specific fashion. In an embodiment implemented using the computing device 900, various computer-readable media might be involved in providing instructions/code to processor(s) 910 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the non-transitory storage device(s) 925. Volatile media include, without limitation, dynamic memory, such as the working memory 935. Transmission media include, without limitation, coaxial cables, copper wire and fiber optics, including the wires that comprise the bus 905, as well as the various components of the communications subsystem 930 (and/or the media by which the communications subsystem 930 provides communication with other devices). Hence, transmission media can also take the form of waves (including without limitation radio, acoustic and/or light waves, such as those generated during radio-wave and infrared data communications).

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media. Data storage media may be any available media that can be accessed by one or more computers or one or more processors to retrieve instructions, code and/or data structures for implementation of the techniques described in this disclosure. “Data storage media” as used herein refers to manufactures and does not refer to transitory propagating signals. By way of example, and not limitation, such computer-readable media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware stored on computer-readable media.

The term “network” and “system” may be used interchangeably herein throughout the present disclosures. A wireless wide area network may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as CDMA2000, Wideband CDMA (W-CDMA), to name just a few radio technologies. Here, CDMA2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). CDMA2000 is described in documents from a consortium named “3rd Generation 10 Partnership Project 2” (3GPP2). 3GPP and 3GPP2 documents are publicly available. A WLAN may include an IEEE 802.11x network, and a WPAN may include a Bluetooth network, an IEEE 802.15x, for example. Such location determination techniques described herein may also be used for any combination of WWAN, WLAN, wireless personal area network (PAN), wireless metropolitan area network (MAN), and/or the like. Accordingly, other systems and networks may be apparent to persons having ordinary skill in the art, and embodiments are not so limited.

A SPS typically includes a system of transmitters positioned to enable entities to determine their location on or above the Earth based, at least in part, on signals received from the transmitters. Such a transmitter typically transmits a signal marked with a repeating pseudo-random noise (PN) code. In a particular example, such transmitters may be located on Earth orbiting space vehicles (SV). For example, a SV in a constellation of Global Navigation Satellite System (GNSS) such as Global Positioning System GPS. Global Navigation Satellite System (GLONASS), etc. may transmit a signal marked with a PN code that is distinguishable from PN codes transmitted by other SVs in the constellation.

In accordance with certain aspects, the techniques presented herein are not restricted to global systems (e.g., GNSS) for SPS. For example, the techniques provided herein may be applied to or otherwise adapted for use in various regional systems, such as, e.g., Quasi-Zenith Satellite System (QZSS) over Japan, Indian Regional Navigational Satellite System (IRNSS) over India, etc., and/or various augmentation systems (e.g., an Satellite Based Augmentation System (SBAS)) that may be associated with or otherwise adapted for use with one or more global and/or regional navigation satellite systems. By way of example but not limitation, an SBAS may include an augmentation system(s) that provide integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Such SBAS may, for example, transmit SPS and/or SPS-like signals that may also be interfered with by certain wireless communication signals, etc. Thus, as used herein, an SPS may include any combination of one or more global and/or regional navigation satellite systems and/or augmentation systems, and SPS signals may include SPS, SPS-like, and/or other signals associated with such one or more SPS.

Various examples have been described. These and other examples are within the scope of the following claims.

What is claimed is:

1. A method for managing wireless transmission duty cycle on a mobile device to mitigate interference during reception of one or more satellite-based positioning signals and transmission of one or more wireless signals, comprising:
determining a first transmission duty cycle, the first transmission duty cycle reflecting a proportion of a time duration occupied by transmission of the one or more wireless signals; and
delaying transmission of a first wireless packet or transmitting at least one portion of the first wireless packet via the one or more wireless signals, based on a comparison of the first transmission duty cycle and a duty cycle threshold.

2. The method of claim 1, wherein transmission of the first wireless packet is delayed, in response to the first transmission duty cycle being greater than or equal to the duty cycle threshold.

3. The method of claim 1, wherein the at least one portion of the first wireless packet is transmitted, in response to the first transmission duty cycle being less than the duty cycle threshold.

4. The method of claim 3, wherein transmitting the at least one portion of the first wireless packet comprises:
transmitting the entire first wireless packet, wherein transmitting the entire first wireless packet allows a resulting transmission duty cycle to be less than the duty cycle threshold.

5. The method of claim 3, wherein transmitting the at least one portion of the first wireless packet comprises:
transmitting a portion of the first wireless packet having a shortened packet length.

6. The method of claim 1, wherein transmission of the one or more wireless signals in a frequency range overlapping a frequency range of the one or more satellite-based positioning signals is associated with an interference condition.

7. The method of claim 1, wherein transmission of two or more wireless signals associated with an intermodulation product in a frequency range overlapping a frequency range of the one or more satellite-based positioning signals is associated with an interference condition.

8. An apparatus for managing wireless transmission duty cycle on a mobile device to mitigate interference during reception of one or more satellite-based positioning signals and transmission of one or more wireless signals, comprising:
a processing unit;
a wireless baseband unit coupled to the processing unit; and
a satellite-based positioning unit coupled to the processing unit,
wherein the processing unit, the wireless baseband unit, or both, are configured to:
determine a first transmission duty cycle, the first transmission duty cycle reflecting a proportion of a time duration occupied by transmission of the one or more wireless signals;
delay transmission of a first wireless packet or transmit at least one portion of the first wireless packet via the one or more wireless signals, based on a comparison of the first transmission duty cycle and a duty cycle threshold.

9. The apparatus of claim 10, wherein the processing unit, the wireless baseband unit, or both, are configured to delay transmission the first wireless packet, in response to the first transmission duty cycle being greater than or equal to the duty cycle threshold.

10. The apparatus of claim 10, wherein the processing unit, the wireless baseband unit, or both, are configured to transmit the at least one portion of the first wireless packet, in response to the first transmission duty cycle being less than the duty cycle threshold.

11. The apparatus of claim 12, wherein the processing unit, the wireless baseband unit, or both, are configured to transmit the at least one portion of the first wireless packet by transmitting the entire first wireless packet, wherein transmitting the entire first wireless packet allows a resulting transmission duty cycle to be less than the duty cycle threshold.

12. The apparatus of claim 12, wherein the processing unit, the wireless baseband unit, or both, are configured to transmit the at least one portion of the first wireless packet by transmitting a portion of the first wireless packet having a shortened packet length.

13. The apparatus of claim 10, wherein transmission of the one or more wireless signals in a frequency range overlapping a frequency range of the one or more satellite-based positioning signals is associated with an interference condition.

14. The apparatus of claim 10, wherein transmission of two or more wireless signals associated with an intermodulation product in a frequency range overlapping a frequency range of the one or more satellite-based positioning signals is associated with an interference condition.

15. An apparatus for managing wireless transmission duty cycle on a mobile device to mitigate interference during reception of one or more satellite-based positioning signals and transmission of one or more wireless signals, comprising:
means for determining a first transmission duty cycle, the first transmission duty cycle reflecting a proportion of a time duration occupied by transmission of the one or more wireless signals; and
means for delaying transmission of a first wireless packet or transmitting at least one portion of the first wireless packet via the one or more wireless signals, based on a comparison of the first transmission duty cycle and a duty cycle threshold.

16. The apparatus of claim 19, wherein the means for delaying transmission or transmitting comprises means for delaying transmission of the first wireless packet, in response to the first transmission duty cycle being greater than or equal to the duty cycle threshold.

17. The apparatus of claim 19, wherein the means for delaying transmission or transmitting comprises means for transmitting the at least one portion of the first wireless packet, in response to the first transmission duty cycle being less than the duty cycle threshold

18. The apparatus of claim 21, wherein the means for transmitting the at least one portion of the first wireless packet comprises:
means for transmitting the entire first wireless packet, wherein transmitting the entire first wireless packet allows a resulting transmission duty cycle to be less than the duty cycle threshold.

19. The apparatus of claim 21, wherein the means for transmitting the at least one portion of the first wireless packet comprises:
means for transmitting a portion of the first wireless packet having a shortened packet length.

20. The apparatus of claim 19, wherein transmission of the one or more wireless signals in a frequency range overlapping a frequency range of the one or more satellite-based positioning signals is associated with an interference condition.
